(19) United States
(12) Patent Application Publication
(10) Pub. No.: US 2024/0111111 A1
(43) Pub. Date: Apr. 4, 2024

(54) FIBER OPTIC CABLE ASSEMBLY WITH IN-LINE DISTRIBUTION HOUSINGS AND METHOD OF MAKING AND USING SAME

(71) Applicant: CORNING RESEARCH & DEVELOPMENT CORPORATION, Corning, NY (US)

(72) Inventors: Terry Lee Cooke, Hickory, NC (US); Lars Kristian Nielsen, Denver, NC (US)

(21) Appl. No.: 18/244,473

(22) Filed: Sep. 11, 2023

Related U.S. Application Data
(60) Provisional application No. 63/411,817, filed on Sep. 30, 2022.

(51) Int. Cl. G02B 6/44; G02B 6/46; G02B 6/48

(52) U.S. Cl. CPC G02B 6/44528; G02B 6/47; G02B 6/483

(57) ABSTRACT

A fiber optic cable assembly includes a fiber optic cable carrying a plurality of optical fibers and a plurality of distribution housings attached to the fiber optic cable at spaced locations along a length of the fiber optic cable. A subset of the plurality of optical fibers carried by the fiber optic cable is terminated at each of the plurality of distribution housings. Each of the plurality of distribution housings includes at least one port interface attached to the respective distribution housing for accessing the subset of optical fibers terminated at the respective distribution housing. The distribution housings are in-line with the cable and have a low-profile for ease of installation. A method of using and making such a fiber optic cable assembly is also disclosed.

### PRIORITY APPLICATION

This application claims the benefit of priority of U.S. Provisional Application No. 63/411,817, filed on Sep. 30, 2022, the content of which is relied upon and incorporated herein by reference in its entirety.

### TECHNICAL FIELD

This disclosure relates generally to fiber optic cables, and more particularly to a fiber optic cable assembly including a plurality of in-line, low-profile distribution housings arranged along a length of the cable, each having at least one adapter for making an optical connection at the housing. The disclosure also relates to a method of making and using the fiber optic cable assembly having such distribution housings.

### BACKGROUND

The large amount of data and other information transmitted over the internet has led businesses and other organizations to develop large scale data centers for organizing, processing, storing and/or disseminating large amounts of data. Data centers contain a wide range of network equipment including, for example, servers, networking switches, routers, storage subsystems, etc. Data centers further include a large amount of cabling and racks to organize and interconnect the network equipment in the data center. Modern data centers may include multi-building campuses having, for example, one primary or main building and a number of auxiliary buildings in close proximity to the main building. All the buildings on the campus are interconnected by a local fiber optic network.

Data center design and cabling-infrastructure architecture are increasingly large and complex. To manage the interconnectivity of a data center, the network equipment within the buildings on the data center campus is often arranged in structured data halls having a large number of spaced-apart rows. Each of the rows is, in turn, configured to receive a number of racks or cabinets (e.g., twenty racks or cabinets) which hold the network equipment. In some data center architectures, each of the rows includes a main patch panel, which may be at a front or head end of the row. Distribution cables with relatively large number of optical fibers (high fiber counts) are routed from a building distribution frame (sometimes referred to as a main distribution frame) to the patch panels for the different rows of equipment racks. At the patch panels, a large number of distribution fiber optic cables with lower fiber counts are connected to the optical fibers of the associated high fiber count distribution cable(s) and routed along the row to connect to the network equipment held in the various racks in the row. To organize the large number of in-row distribution fiber optic cables, each row typically includes a cable tray or basket disposed above the row for supporting the distribution fiber optic cables as they extend along the row. The network equipment in the racks is optically connected to the distribution fiber optic cables by technicians during the construction of the data center.

While current data center design and cabling-infrastructure architecture are satisfactory for the current needs of the industry, the labor, installation time, and costs to achieve the interconnectivity of the data center can be high. For these reasons, manufacturers continually strive to improve the interconnectivity in the data center. For example, one approach to improve optical infrastructure installation efficiency is to pre-engineer infrastructure components. Such components, such as fiber optic cables, may be pre-terminated in a factory with connectors installed, tested, and packaged for fast, easy, and safe installation at a data center. In this way, an installer would unpack the components, pull or route the pre-connectorized fiber optic cable, snap in connectors (e.g., such as at the row patch panel), and install jumpers to end equipment. This saves a significant amount of time, effort, and costs compared to on-site connectorization and assembly of cables.

By way of example, various pre-engineered cables for row interconnectivity at data centers are disclosed in PCT Patent Publication No. WO2020214762A1 (“the '762 publication”), the disclosure of which is incorporated herein by reference. As disclosed in the '762 publication, a pre-engineered cable may be a high-fiber count cable having a pre-connectorized distribution end for connection to the main patch panel for a row (e.g., at a head end of the row). The fiber optic cable then has a plurality of distributed drop cables (also referred to as “tap cables”) that extend from the main cable at drop points (“tap points”) along the length of the cable. The drop points along the fiber optic cable are designed to correspond to the rack spacing and configuration in the row. The ends of the drop cables are also pre-connectorized for easy and quick connection to the network equipment in the racks positioned in the row. In this way, the -pre-engineered fiber optic cable may be removed from its packaging, routed along the cable tray so that the drop points correspond in location to the racks in the row, connected at the distribution end of the cable to the main patch panel, and connected at the pre-connectorized ends of the drop cables to the respective network equipment in the racks. With such a pre-engineered fiber optic cable, it is estimated that installation time for row interconnectivity may be reduced from several hours to several minutes.

While pre-engineered cables like those in the '762 publication may assist with reducing labor, installation time and costs, the demand for even faster, lower cost installation remains. data center

### SUMMARY

In one aspect of the disclosure, a fiber optic cable assembly includes a fiber optic cable carrying a plurality of optical fibers and a plurality of distribution housings attached to the fiber optic cable along a length of the fiber optic cable. A subset of the plurality of optical fibers carried by the fiber optic cable is terminated at each of the plurality of distribution housings. Moreover, each of the plurality of distribution housings includes at least one port interface attached to the respective distribution housing for accessing the subset of optical fibers terminated at the respective distribution housing.

In one embodiment, the plurality of distribution housings may be configured to have an in-line, low-profile configuration relative to the fiber optic cable. For example, in one embodiment, each of the plurality of distribution housings may be disposed about the fiber optic cable such that the plurality of optical fibers carried by the fiber optic cable extends into an interior of the respective distribution housing. Moreover, the fiber optic cable may have a radius R relative to a cable axis, and each of the plurality of distribution housings may be arranged such that the respective distribution housing is within an envelope about the cable axis of no greater than about 4R, preferably no greater than about 3R, and even more preferably no greater than about 2.5R. The in-line, low-profile configuration of the distribution housings obviates the need for tethers or drop cables and further provides reduced snagging of the fiber optic cable assembly during installation.

In one embodiment, for each of the plurality of distribution housings, the port interface may include a first interface portion positioned interior of the respective distribution housing and defining a plurality of interior ports and a second interface portion positioned exterior of the respective distribution housing and defining a plurality of exterior ports. Each of the plurality of interior ports may be configured to receive one or more of the subset of optical fibers terminated at the respective distribution housing. Furthermore, each of the plurality of exterior ports may be configured to receive a connection from network equipment or other fiber optic devices, for example. In one embodiment, the port interface includes a multi-port adapter. Providing connection ports at, but external to, the distribution housing makes for easy access for making optical connections. The at least one port interface may have an interface axis and a width along the interface axis. In one embodiment, the width of the at least one port interface may be between about 1.5 and about 2.0 times the diameter of the fiber optic cable immediately adjacent the respective distribution housing. Moreover, in one embodiment, each of the plurality of distribution housings may include at least one recess and the second interface portion of the at least one port interface may be substantially positioned in the at least one recess. This provides further low-profile, anti-snag features that facilitate installation of the fiber optic cable assembly, such as in a data center environment.

In a further embodiment, the fiber optic cable assembly may further include a plurality of cable hangers for connecting the plurality of distribution housings to a cable support. In one embodiment, each of the plurality of distribution housings may include at least one key or keyway and each of the plurality of cable hangers may include the other of the at least one key or keyway. In this way, a respective distribution housing and a respective cable hanger may be configured to be connected by engagement of the at least one key and keyway. This key/keyway arrangement provides a quick and easy way to connect the cable hangers to the distribution housings. In an exemplary embodiment, each of the plurality of distribution housings may include at least one keyway configured as a T-shaped slot and each of the plurality of cable hangers may include a key configured as a T-shaped flange. The T-shaped flange may be configured to slidably engage the T-shaped slot, such as through a friction fit, to form the connection.

In one embodiment, each of the plurality of cable hangers may include a clip or latch for selectively engaging the respective cable hanger with the cable support. In another embodiment, each of the plurality of cable hangers may include an enlarged head for selectively engaging the respective cable hanger with the cable support. In an exemplary embodiment, the enlarged head may be configured to slide relative to the cable support.

In a second aspect of the disclosure, a fiber optic cable system includes a cable support and the fiber optic cable assembly according to the first aspect above. A plurality of cable hangers is configured to connect the plurality of distribution housings to the cable support such that the fiber optic cable assembly is suspended from the cable support. A suspended cable arrangement is configured to further improve installation of the fiber optic cable assembly.

In one embodiment, the cable support may include at least one elongate rail and the plurality of cable hangers may be configured to slidably connect to the at least one rail. More particularly, in one embodiment, the at least one rail may include at least one wall defining a rail interior and an opening through the at least one wall for accessing the rail interior. In this embodiment, each of the plurality of cable hangers may include a first orientation that allows the respective cable hanger to pass through the opening and a second orientation that prevents the respective cable hanger from passing through the opening.

In a third aspect of the disclosure, a method of installing a fiber optic cable assembly according to the first aspect above to a cable support includes routing the fiber optic cable assembly along the cable support and suspending the fiber optic cable assembly from the cable support using the plurality of cable hangers.

In one embodiment, suspending the fiber optic cable assembly from the cable support may further include selectively connecting a first portion of each of the plurality of cable hangers to the cable support and selectively connecting a second portion of each of the plurality of cable hangers to a respective distribution housing of the plurality of distribution housings. In one embodiment, selectively connecting the first portion of each of the plurality of cable hangers to the cable support may further include clipping or latching the first portion to the cable support. In an alternative embodiment, however, selectively connecting the first portion of each of the plurality of cable hangers to the cable support may include placing at least the first portion of the respective cable hanger in a first orientation relative to the cable support, engaging the first portion of the respective cable hanger to the cable support when in the first orientation, and placing the at least first portion of the respective cable hanger in a second orientation to thereby secure the respective cable hanger to the cable support.

In one embodiment, placing the at least first portion of the respective cable hanger in the first orientation may further include rotating the at least first portion of the respective cable hanger to permit the first portion to pass through an opening in the cable support, and placing the at least first portion of the respective cable hanger in the second orientation may further include rotating the at least first portion of the respective cable hanger to prevent the first portion from passing through the opening in the cable support.

In one embodiment, selectively connecting the second portion of each of the plurality cable hangers to the cable support may further include engaging a key on one of the respective cable hanger and respective distribution housing with a keyway on the other of the respective cable hanger and the respective distribution housing.

In a fourth aspect of the disclosure, a method of installing a fiber optic cable assembly according to the first aspect above to a cable support includes selectively connecting each of the plurality of cable hangers to a respective distribution housing of the plurality of distribution housings; engaging an end-most cable hanger adjacent a first end of the fiber optic cable assembly with the cable support at an engagement location of the cable support; moving the fiber optic cable assembly along the cable support; and engaging successive respective cable hangers with the cable support at the engagement location as the fiber optic cable assembly is moved along the cable support. In this threading-type process, once respective cable hangers are engaged with the cable support, the respective cable hangers may be configured to move along the cable support as the fiber optic cable is being moved along the cable support. By way of example, the respective cable hangers may be configured to slidably move along the cable support.

In another aspect of the disclosure, a method of making a fiber optic cable assembly includes providing a fiber optic cable carrying a plurality of optical fibers; selecting a plurality of distribution locations along a length of the fiber optic cable; and wherein at each of the distribution locations, the method further includes terminating a subset of the plurality of optical fibers with a plurality of connectors and/or ferrules; providing at least one multi-port adapter including a first portion with a plurality of first ports and a second portion with a plurality of second ports and engaging the plurality of connectors and/or ferrules of the subset of terminated optical fibers with respective first ports of the multi-port adapter; and disposing a distribution housing about the fiber optic cable such that the at least one multi-port adapter is attached to the distribution housing, the first portion is in an interior of the distribution housing, and the second portion is external of the distribution housing.

In one embodiment, the fiber optic cable may have a radius R relative to a cable axis and disposing the distribution housing about the fiber optic cable may further include disposing the distribution housing within an envelope about the cable axis of no greater than about 4R, preferably no greater than about 3R, and even more preferably no greater than about 2.5R. Moreover, in one embodiment, the distribution housing may include at least one recess and disposing the distribution housing about the fiber optic cable may further include locating the at least one multi-port adapter substantially within the at least one recess. In one embodiment, the distribution housing may include at least one key or keyway formed therein for connecting the distribution housing to a cable support. In one embodiment, parts of the distribution housing may be injection molded and assembly about the fiber optic cable at the distribution locations. Alternatively, the distribution housings may be formed through an over-molding process about the fiber optic cable at the distribution locations.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an exemplary embodiment of the disclosure.

FIGS. 2 and 2A are partial perspective views of an exemplary data hall of the data center shown in FIG. 1 according to one embodiment.

FIG. 3 is a schematic view of a fiber optic distribution cable assembly in accordance with an embodiment of the disclosure.

FIG. 4 is an exemplary cross-sectional view of the fiber optic cable of the cable assembly shown in FIG. 3 according to an embodiment of the disclosure.

FIGS. 5A-5E are various views of a distribution housing of the distribution cable assembly according to an embodiment of the disclosure.

FIG. 6 is a schematic perspective view of a multi-port adapter used in the distribution housings of the distribution cable assembly according to an embodiment of the disclosure.

FIG. 7 is a flowchart of a method of making the distribution cable assembly shown in FIG. 3 according to an embodiment of the disclosure.

FIGS. 8A and 8B are schematic views of a suspension arrangement of the distribution cable assembly according to an embodiment of the disclosure.

FIG. 9 is a schematic view of another suspension arrangement of the distribution cable assembly according to an embodiment of the disclosure.

FIG. 10 is a cross-sectional view of the suspension arrangement illustrated in FIG. 9.

FIGS. 11A-11C are schematic views illustrating the connection of cable hangars to a cable support according to an embodiment of the disclosure.

FIG. 12 is a schematic view illustrating the threading of the distribution cable assembly onto the cable support in accordance with an embodiment of the disclosure.

### DETAILED DESCRIPTION

Various embodiments will be further clarified by examples in the description below. In general, the description relates to a fiber optic distribution cable assembly including a fiber optic cable and a plurality of distribution housings spaced along a length of the cable. The distribution housings are configured to be in-line with the fiber optic cable, such as generally being disposed about the fiber optic cable and have a low-profile such that the distribution housings remain in close proximity to the fiber optic cable. In this way, the distribution housings avoid or limit snagging and other obstacles during installation of the distribution cable assembly. The spacing between the distribution housings along the length of the cable generally correspond with the spacing between racks in a row in a data hall of a data center such that when the distribution cable assembly is installed, the distribution housings are disposed generally above the racks in the row. A subset of optical fibers carried by the fiber optic cable are terminated and presented for optical connection at the distribution housings. More particularly, the distribution housings include a multi-port adapter for providing a connection to the terminated optical fibers. Thus, the distribution cable assembly provides no tether or drop cables extending from the main fiber optic cable. Instead, the in-line and low-profile distribution housings provide the optical interface (i.e., the multi-port adapter) for making optical connections to the network equipment in the racks. To further enhance the anti-snag aspect of the distribution cable assembly, the (exposed) connection ports of the adapters may be recessed within the body of the distribution housings to eliminate or minimize any extension of the adapter beyond the outer confines of the housings.

The description also relates to a fiber optic distribution cable system arranged for suspension of the distribution cable assembly. The system includes a cable support, such as an elongate sliding rail, the distribution cable assembly, and a plurality of cable hangers that suspend the distribution cable assembly from the cable support. The cable hangers may be selectively connected to the cable support and to the distribution housings. Thus, to install the distribution cable assembly, the cable hangers may be connected to the cable support, the distribution cable assembly may be routed along the row in the data center, and then the cable hangers may be connected to the distribution housings to thereby suspend the distribution cable assembly from the cable support. Alternatively, for installation, the cable hangers may be connected to the distribution housings and then the distribution cable assembly may be threaded onto the cable support to provide the suspended arrangement. The various features of the distribution cable assembly and the distribution cable system, as described more fully below, provide further reductions in installation time, labor, and costs for data center construction.

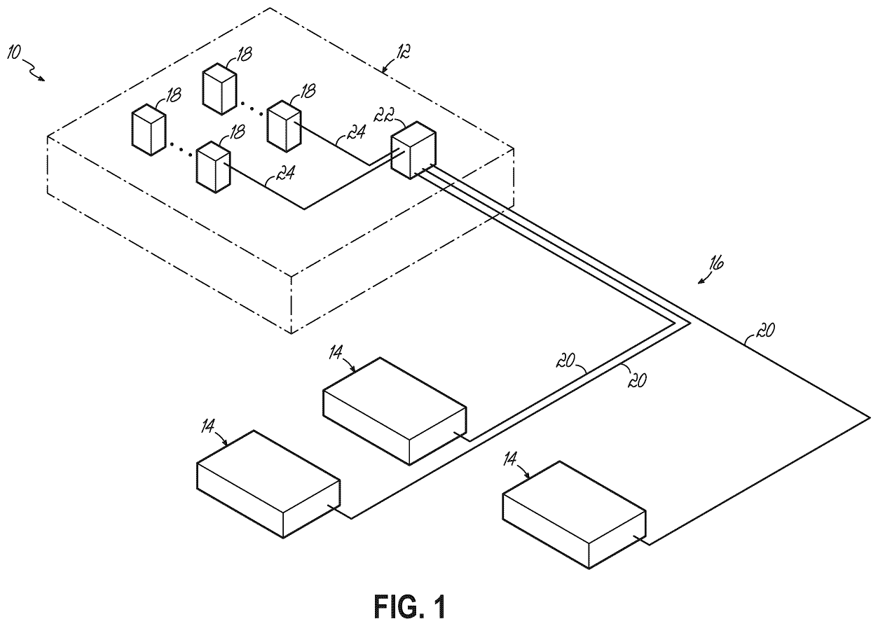

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings are shown, there may be more or less depending on the size of the campus. The data center 10 provides for a local fiber optic network 16 that interconnects the auxiliary buildings 14 with the main building 12. The local fiber optic network 16 allows IT equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 (“indoor cables 24”) are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

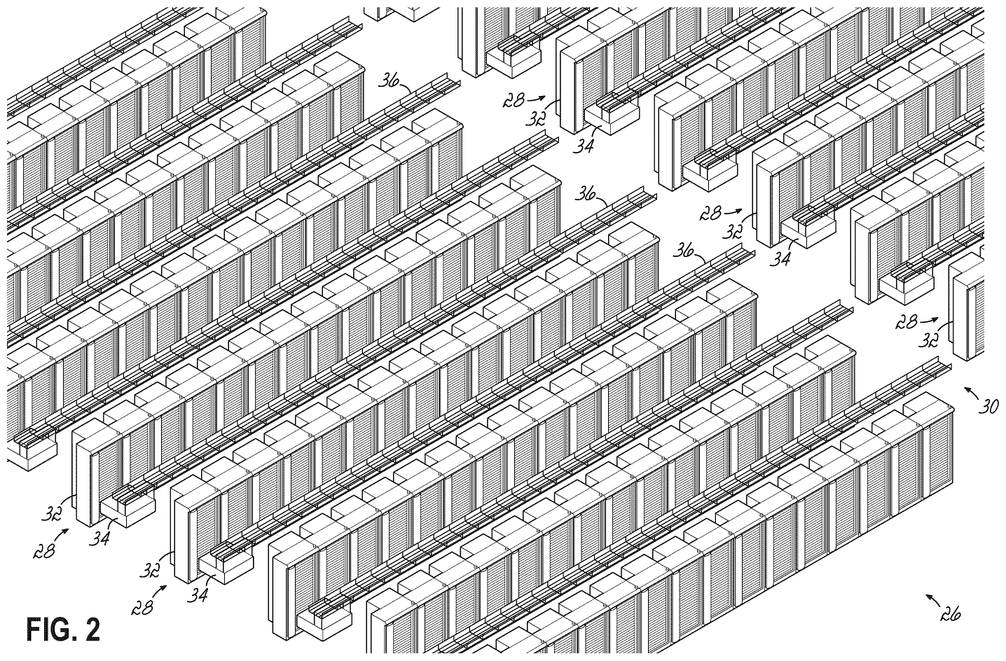

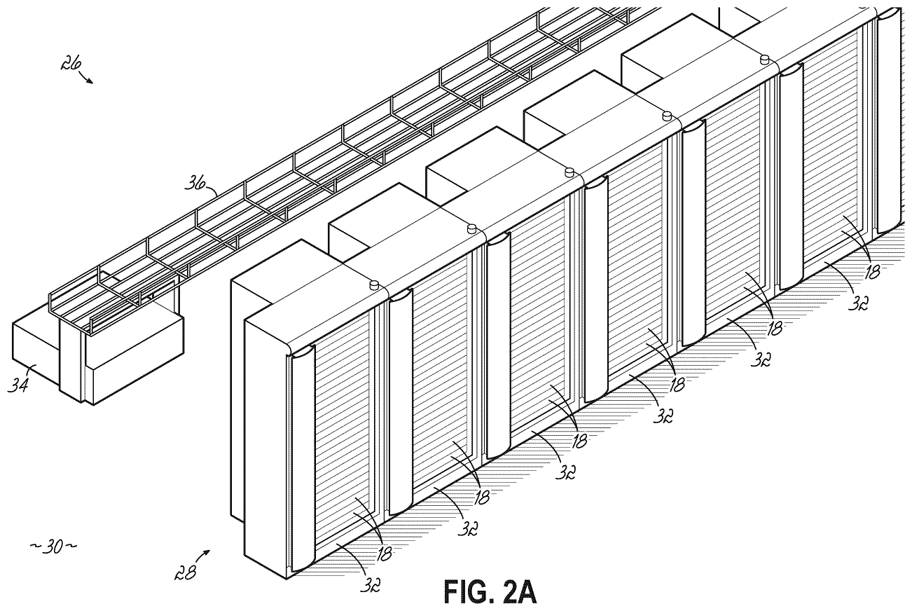

As illustrated in more detail in FIGS. 2 and 2A, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of racks or cabinets 32 (referred to hereafter as “racks 32”) generally arranged one next to the other along the row 28. Each of the racks 32 are vertically arranged frames for holding various network equipment 18 of the data center 10, as is generally known in the fiber optics industry. In one common arrangement, and as further illustrated in FIG. 2, each row 28 may include a patch panel 34 at the front or head end of the row 28 closest to the access pathway 30. The patch panel 34 represents a termination point of at least some of the optical fibers carried by one or more of the indoor cables 24, for example. In other embodiments, the patch panel 34 may be located within the associated row, such as in the middle of the row.

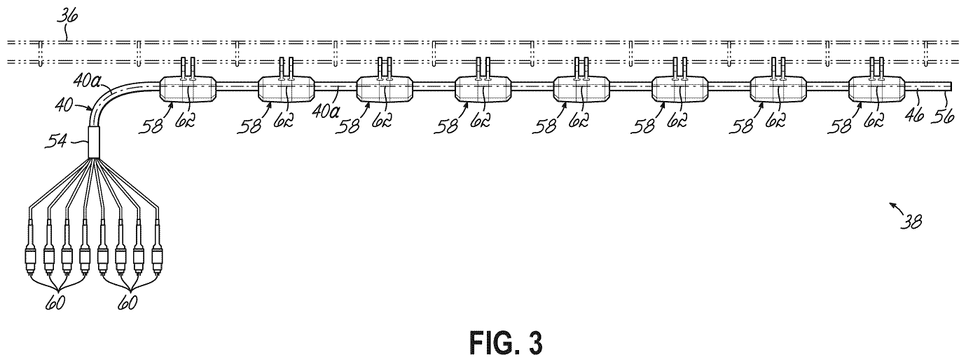

As discussed above, in a conventional arrangement, one or more distribution cables are connected to the patch panel 34 of a row 28 and routed along a cable tray 36 generally disposed above the row 28. The network equipment 18 in the racks 32 is then optically connected to the one or more distribution cables to provide the interconnectivity of the network equipment 18 of the data center 10. Aspects of the present disclosure are directed to an improved fiber optic distribution cable assembly configured to be connected to the patch panel 34 of a row 28 and routed along the cable tray 36 or other cable support of the row 28 for connection to the network equipment 18 in the racks 32 that make up the row 28. FIG. 3 illustrates an exemplary fiber optic distribution cable assembly 38 (“distribution cable assembly 38”) in accordance with an embodiment of the disclosure. Although the distribution cable assembly 38 will be discussed in more detail below in the context of a fiber optic cable assembly connected between the patch panel 34 at the head end of a row 28 and the network equipment 18 in the racks 32 of the row 28, the distribution cable assembly 38 is not limited to such an application. Accordingly, it should be understood that the distribution cable assembly 38 may be used in other contexts of a data center, or other contexts of a fiber optic network more generally.

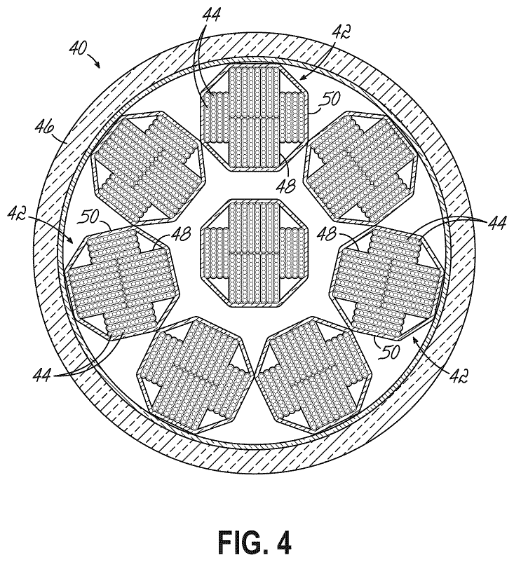

As illustrated in FIGS. 3 and 4, the distribution cable assembly 38 generally includes fiber optic cable 40 that carries optical fibers for passing data and other information through the local fiber optic network 16, and more specifically between the patch panel 34 and the network equipment 18 in a row 28. The number of optical fibers carried by the fiber optic cable 40 and how they are arranged within the fiber optic cable 40 may vary based on the application. FIG. 4 illustrates one example arrangement merely to facilitate discussion.

In the example shown in FIG. 4, the fiber optic cable 40 includes a plurality of subunits 42, and each subunit 42 is configured to carry a pre-selected number of optical fibers 44. Although the fiber optic cable 40 is shown as including eight subunits 42, the number of subunits 42 may be more or less than this number in alternative embodiments. The subunits 42 may be arranged within an outer protective sheath 46 (“outer jacket 46”), as is generally known in the industry. As mentioned above, each of the subunits 42 is configured to carry a pre-selected number of optical fibers 44. By way of example and without limitation, each subunit 42 may be configured to carry 96, 144, or 288 optical fibers 44. It should be recognized, however, that more or less optical fibers 44 may be carried by each of the subunits 42.

In one embodiment, the optical fibers 44 in the subunits 42 may be configured as a plurality of fiber optic ribbons 48 (“ribbons 48”). Each ribbon 48 includes a plurality of the optical fibers 44 arranged in a generally side-by-side manner (e.g., a linear array, as shown, or a rolled/folded array). Such ribbons are generally known in the art and thus will not be further described herein. In one embodiment, for example, each ribbon 48 may be configured to include eight, twelve, or twenty-four optical fibers 44. It should be recognized, however, that each ribbon 48 may include more or less optical fibers 44 in various alternative embodiments. The ribbons 48 of a subunit 42 may be arranged within a subunit sheath 50 (“subunit jacket 50”), which may be a thin layer of material that has been extruded over the ribbons 48.

In reference to FIG. 3, the distribution cable assembly 38 includes the fiber optic cable 40 having a first distribution end 54, a second terminal end 56 opposite the distribution end 54, and a plurality of distribution housings 58 disposed along the length of the fiber optic cable 40 between the distribution end 54 and the terminal end 56. The distribution end 54 of the fiber optic cable 40 includes a plurality of connectors 60 that terminate one or more of the optical fibers 44 carried by the cable 40 and is configured to be connected to optical interfaces associated with the patch panel 34 at the head end of the rows 28 in the data hall 26. Any conventional, or yet to be developed, optical connector or connectorization scheme may be used in accordance with the present disclosure, including, but not limited to simplex or duplex connectors (e.g., LC connectors) and multi-fiber connectors (e.g., MPO connectors). For example, the connectors 60 may include MPO (multi-fiber push on) connectors, which are configured for multi-fiber cables including multiple sub-units of optical fibers (e.g., between four to 24 optical fibers). In other embodiments, the connectors 60 may be a different type of multi-fiber connector, such as an SN-MT connector commercially available from Senko Advanced Components, Inc. or an MMC connector commercially available from US Conec Ltd. As discussed above, the connectors 60 at the distribution end 54 of the fiber optic cable 40 may be pre-connectorized to avoid field assembly of the connectors 60 to the cable 40.

The distribution housings 58 of the distribution cable assembly 38 are arranged at distribution points or locations 62 along the length of the fiber optic cable 40. The distribution locations 62 have a distribution pattern along the fiber optic cable 40 that generally corresponds to the spacing between the racks 32 in the row 28 in which the distribution cable assembly 38 is being installed. In this way, when the distribution cable assembly 38 is installed, the distribution housings 58 are generally disposed above respective racks 32 in the row 28. In one embodiment, the distribution locations 62 may be uniformly spaced along the length of the fiber optic cable 40 and correspond to uniformly spaced racks 32 in the row 28. In an alternative embodiment, however, the distribution locations 62 may be non-uniformly spaced along the length of the fiber optic cable 40 and correspond to non-uniformly spaced racks 32 in the row 28.

The distribution housings 58 of the distribution cable assembly 38 represent the termination point of a subset of optical fibers 44 being carried by the fiber optic cable 40 and presents an optical interface for making optical connections to the terminated subset of optical fibers 44. In an exemplary embodiment, the distribution housings 58, and the termination of the subset of optical fibers 44, may be arranged in the immediate vicinity of the fiber optic cable 40. In other words, in distribution cable assembly 38, there are no tethers or drop cables extending away from the distribution housings 58 for presenting optical interfaces (e.g., connectors) at some distance from the cable 40 itself. Instead, the optical interfaces for accessing the subset of terminated optical fibers 44 are essentially at the fiber optic cable 40 itself, e.g., less than 100 cm, preferably less than 50 cm, and even more preferably less than 20 cm from the cable 40. At these distances, the distribution housings 58 may be referred to as being in-line with the fiber optic cable 40.

In an exemplary embodiment, for example, the distribution housings 58 may be generally disposed about the fiber optic cable 40 such that the cable passes through an interior of the housings 58. In such an embodiment, the distribution housings 58 may surround the fiber optic cable 40 and effectively represent a slightly expanded portion of the cable itself. By way of example, in one embodiment, if the fiber optic cable 40 has a radius of R relative to a central axis 40a of the cable 40, then the distribution housings 58 may be within an envelope disposed about the fiber optic cable 40 no greater than about 4R, preferably no greater than about 3R, and even more preferably no greater than about 2.5R relative to the central cable axis 40a. Again, such a configuration not only maintains the distribution housings 58 essentially “in-line” with the fiber optic cable 40, but also provides the distribution housings with a low profile.

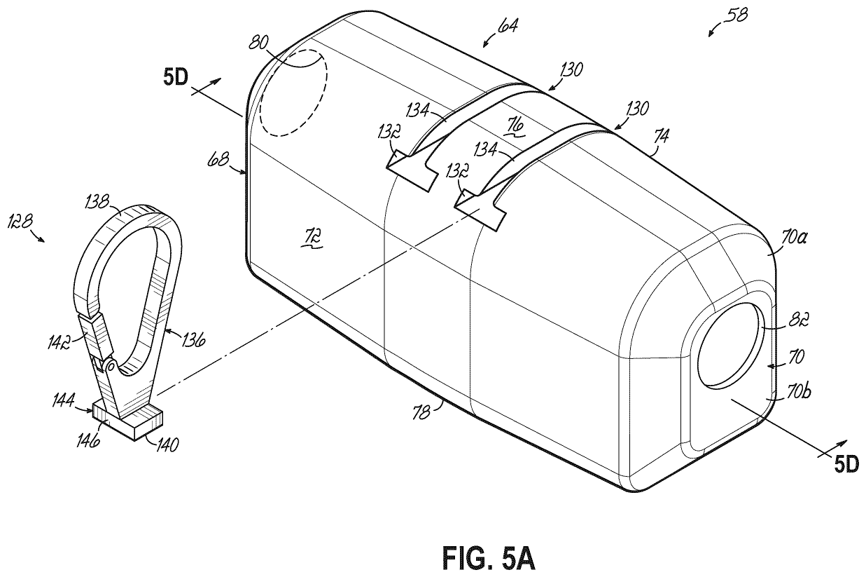

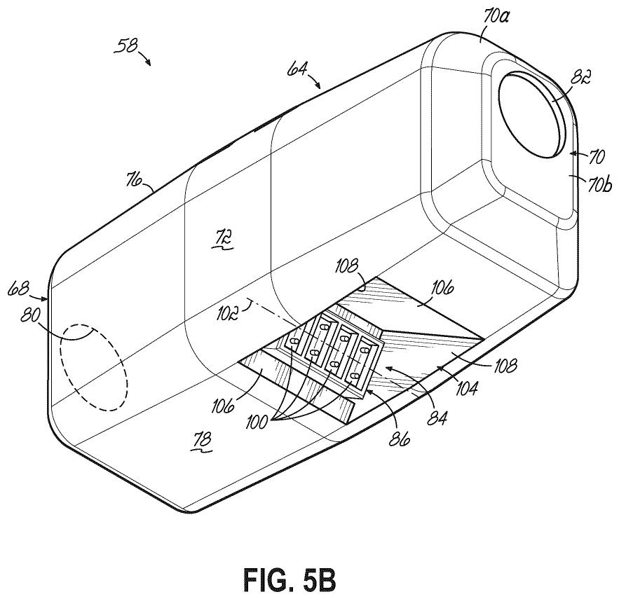

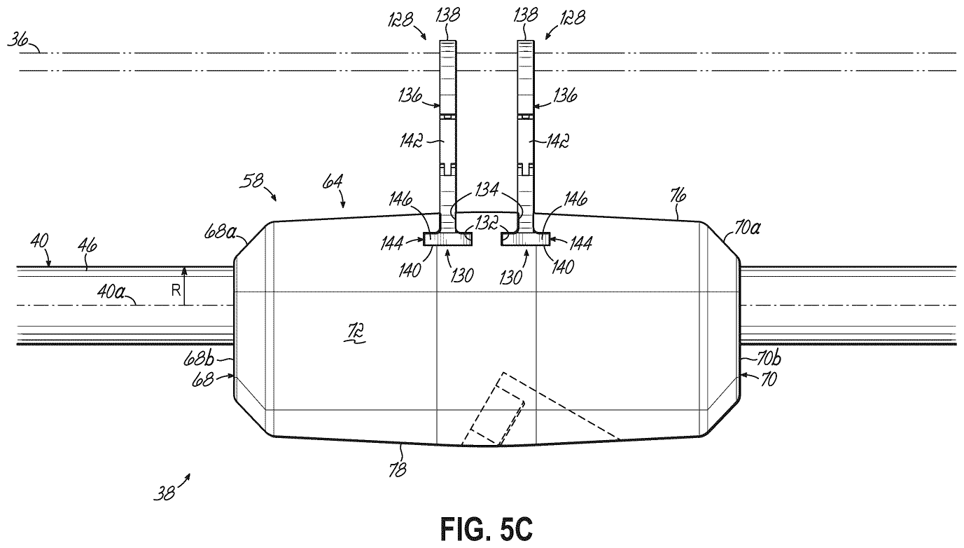

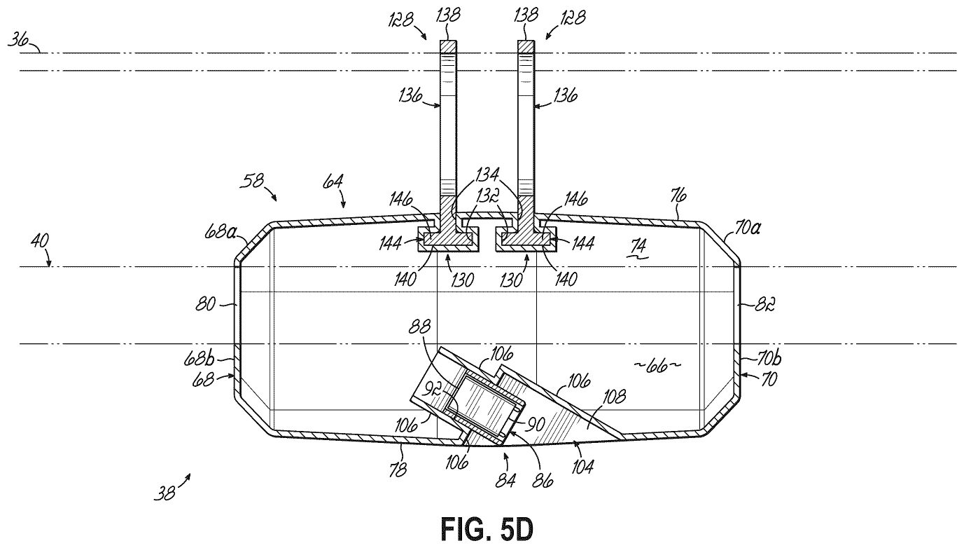

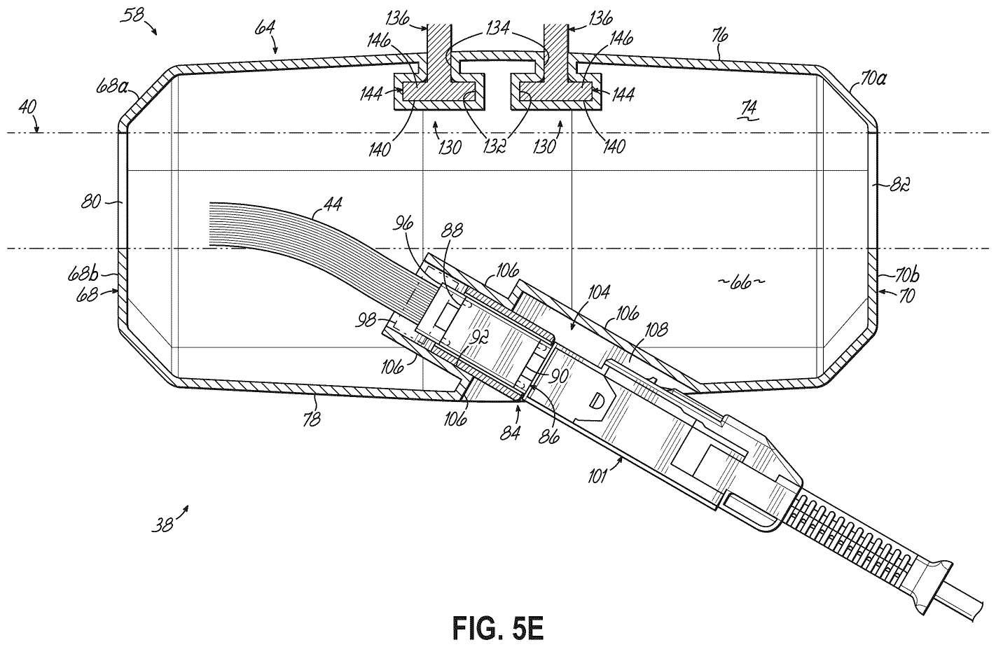

As illustrated in FIGS. 5A-5E, in an exemplary embodiment, the distribution housing 58 includes one or more walls that define an outer boundary or shell 64 and a housing interior 66. In one embodiment, the distribution housing 58 may be generally rectangular in shape and include a front end wall 68, a rear end wall 70 generally opposing the front end wall 68, a front side wall 72, a rear side wall 74 generally opposing the front side wall 72, a top wall 76, and a bottom wall 78 generally opposing the top wall 76. The terms “front”, “rear”, “top”, and “bottom” are for purposes of description and should not limit the distribution housing 58 to any particular orientation. Moreover, while the above/below describes the distribution housing 58 as rectangular in shape, it should be understood that the distribution housing 58 may have different geometric shapes and remain within the scope of the present disclosure. In one embodiment, the distribution housing 58 may be formed from a rigid plastic material, such as rigid engineering plastics including polyethylene, acrylonitrile butadiene styrene, polypropylene, and other plastics. Other non-plastic materials may also be used.

In one embodiment, the distribution housings 58 may be injection molded bodies (e.g., such as in two or more body portions) formed separately and then snap-fit together or otherwise connect together about the fiber optic cable 40 at the distribution locations 62. In an alternative embodiment, however, the distribution housings 58 may be over-molded onto the fiber optic cable 40 at the distribution locations 62. The molding processes are well understood and a further description will be omitted for sake of brevity. The above are exemplary methods for making the distribution housings 58 and it should be recognized that other methods may be used to form the housings 58 either separate from or directly on the fiber optic cable 40.

As mentioned above, in one embodiment, the distribution housings 58 are disposed about the fiber optic cable 40 such that the optical fibers 44 carried by the fiber optic cable 40 extend into the interior 66 of the housings 58. Thus, in one embodiment, the front end wall 68 of the distribution housing 58 may include an aperture 80 for allowing optical fibers 44 of the fiber optic cable 40 to pass into the housing 58. In a similar manner, the rear end wall 70 of the distribution housing 58 may also include an aperture 82 for allowing optical fibers 44 of the fiber optic cable 40 pass out of the housing 58. Preferably, the apertures 80, 82 are axially aligned in the housing 58. Should there be a distribution housing 58 at the terminal end 56 of the fiber optic cable 40, then the aperture 82 in the rear end wall 70 of the housing 58 may be omitted. Of course, the number of optical fibers 44 that pass into the distribution housing 58 is greater than the number of optical fibers 44 that pass out of the distribution housing 58 by the number of optical fibers 44 that are terminated at the housing 58. Thus, the size of the apertures 80, 82 may be slightly different to accommodate the size of the fiber optic cable 40 on the opposing ends of the distribution housing 58. Additionally, the front end wall 68 and the rear end wall 70 may include tapered or chamfered portions 68a, 70a that are angled (e.g., between 30-60 degrees) relative to planar portions 68b, 70b and extend to the edges of the adjacent walls 72, 74, 76, 78 of the distribution housing 58. Such a configuration of the front end wall 68 and the rear end wall 70 further provides a low-profile, anti-snag feature configured to reduce or eliminate snagging of the distribution housings 58 during installation of the distribution cable assembly 38.

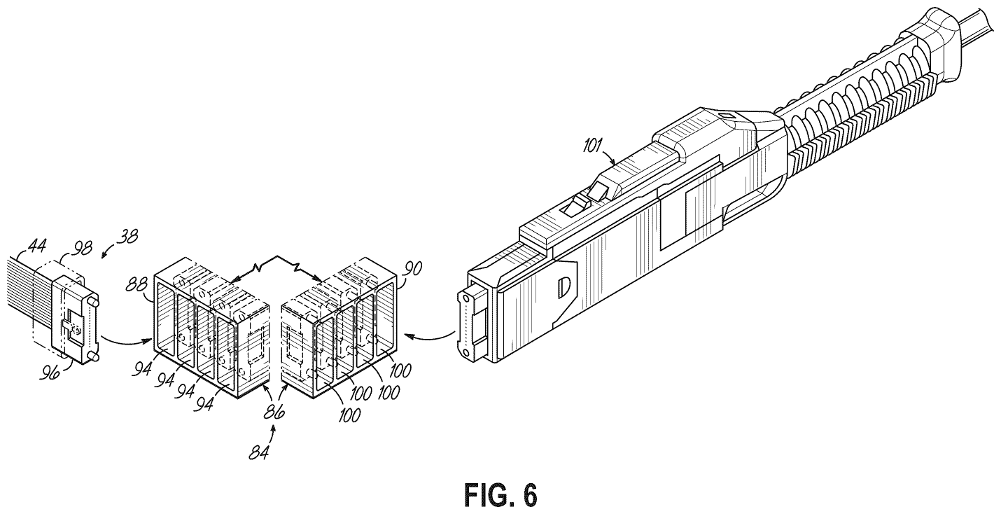

As mentioned above, the subset of optical fibers 44 that are terminated at the distribution housing 58 include an optical interface 84 at which the terminated optical fibers 44 may be externally accessed. In an exemplary embodiment, the optical interface 84 may include at least one adapter 86, such as a two-port, three-port, or four-port adapter, that is affixed to the housing 58 and provides access to the optical fibers 44 terminated at the housing 58. While one adapter 86 is shown in FIGS. 5B-5E, it should be understood that the distribution housings 58 may include two or more adapters 86. As illustrated in FIG. 6, each adapter 86 includes a rear adapter portion 88 and a front adapter portion 90. With the adapter 86 affixed to the distribution housing 58, the rear adapter portion 88 is generally positioned in the interior 66 of the distribution housing 58 and the adapter 86 extends through an aperture 92 in the housing 58 such that front adapter portion 90 is accessible from outside the housing 58. In an exemplary embodiment, the adapter 86 may be affixed to the housing 58 such that aperture 92 through which the adapter 86 extends is located in the bottom wall 78 of the housing 58. Thus, the terminated optical fibers 44 may be accessible along the front adapter portion 90 of the adapter 86 via at the bottom wall 78 of the distribution housing 58. This arrangement may be preferable since, when the distribution cable assembly 38 is installed along a row 28, it is the bottom wall 78 of the distribution housings 58 that generally confronts the racks 32 in the row 28. It should be recognized, however, that the at least one adapter 86 may be arranged so as to extend through other walls of the distribution housings 58, such as the front or rear side walls 72, 74, to provide access to the terminated optical fibers 44. Thus, the number of adapters 86 and the position of the adapters 86 should not be limited to that shown and described herein.

As illustrated in FIG. 6, the rear adapter portion 88 of the adapter 86 includes a plurality of rear ports 94 each of which is configured to receive one or more of the terminated optical fibers 44 of the fiber optic cable 40. For example, the subset of optical fibers 44 terminated at each of the distribution housings 58 may be pre-connectorized with a plurality of connectors or ferrules that is configured to be received in respective ports 94 in the rear portion 88 of the adapter 86. In one embodiment, for example, the terminated optical fibers 44 of the fiber optic cable 40 may be pre-connectorized by a multi-fiber ferrule 96, such as a MT ferrule for MPO connectors, SN-MT connectors, or MMC connectors. In the embodiment shown, the multi-fiber ferrule 96 comprises an ferrule for MMC connectors, and such ferrules 96 may be referred to as TMT ferrules by US Conec Ltd. Accordingly, each of the rear ports 94 may then be configured to receive the multi-fiber ferrule 96 therein. Alternatively, the terminated optical fibers 44 of the fiber optic cable 40 at each of the distribution housings 58 may be pre-connectorized by a multi-fiber connector. In one embodiment, for example, the terminated optical fibers 44 may be connectorized by a plurality of “junior” (Jr.) connectors, which utilize the same ferrules as a corresponding multi-fiber connector (e.g., MPO, SN-MT, or MMC) as well as a small connector housing 98, and which are configured to be received in the rear ports 94 of the adapter 86. It should be appreciated that the termination of the optical fibers 44 at the distribution housings 58 are not limited to the TMT ferrules and MMC Jr. connectors shown in FIG. 6, and other single-fiber or multi-fiber connectors and/or ferrules may be used to pre-connectorize the terminated optical fibers 44.

Similar to the above, the front adapter portion 90 of the adapter 86 includes a plurality of front ports 100 each of which corresponds to a respective rear port 94 of the adapter 86. Each of the front ports 100 may be configured to receive a connector 101, such as one connected to the network equipment 18 in a rack 32. The connectors may be simplex or duplex connectors (e.g., LC connectors) or multi-fiber connectors (e.g., MPO, SN-MT, or MMC connectors). In the example embodiment shown, the front ports 100 are configured to receive MMC connectors 101 similar to that described above. Other types of connectors, including other multi-fiber connectors are also possible. As noted above, because the front ports 100 of the adapter 86 are accessible from outside the distribution housing 58, such connectors 101 may be easily inserted into the ports 100 of the adapter 86.

The adapter 86 generally defines an adapter axis 102 along which the ports 94, 100 of the adapter 86 are arranged (i.e., the ports 94, 100 are serially arranged along the adapter axis 102). In an exemplary embodiment, the adapter 86 may be affixed to the distribution housing 58 such that the adapter axis 102 is transverse to the cable axis 40a. For example, the adapter 86 may be affixed to the distribution housing 58 such that the adapter axis 102 is substantially perpendicular to the cable axis 40a (e.g., 90°+/−5°). In this orientation, the adapter 86 may be configured to have a minimal transverse dimension (e.g., a width dimension) so that the distribution housing 58 may remain within as small an envelope about the fiber optic cable 40 as possible. By way of example, in one embodiment, the multi-port adapter 86 may have a width (i.e., length dimension of the adapter 86 along the adapter axis 102) between about 1.5D and about 2D, where D is the diameter of the fiber optic cable 40 at the front end wall 68 of the distribution housing 58. In this way, the optical interface 84 for accessing the terminated optical fibers 44 of the distribution housing 58 is not much larger than the fiber optic cable 40 itself. And with locating the optical interface 84 close to the fiber optic cable 40, the distribution cable assembly 38 maintains the in-line, low profile configuration that reduces snagging during installation of the cable assembly 38.

While the above was described with the orientation of the adapter 86 being transverse to the cable axis 40a, implementation is not limited to such an orientation. For example, in an alternative embodiment, the adapter 86 may be affixed to the distribution housing 58 such that the adapter axis 102 is generally aligned with the cable axis 40a. For example, the adapter 86 may be affixed to the distribution housing 58 such that the adapter axis 102 is substantially parallel to the cable axis 40a (e.g., +/−5°). Similar to the above, in this orientation, the adapter 86 may be configured to have a minimal transverse dimension so that the distribution housing 58 may remain within as small an envelope about the distribution cable 40 as possible. Thus, the optical interface 84 for accessing the terminated optical fibers 44 of the housing 58 is not much larger than the distribution cable 40 itself and the distribution cable assembly 38 maintains the in-line, low-profile configuration that reduces snagging during installation of the cable assembly 38. Other orientation of the adapter 86 relative to the distribution housing 58 and cable axis 40a may also be possible to reduce snagging during installation.

To further reduce the likelihood of snagging during installation of the distribution cable assembly 38, the adapter 86, and more particularly the front adapter portion 90 that is externally accessible, may be disposed within a depression or recess 104 in the distribution housing 58. For example, as illustrated in FIGS. 5B-5E, the bottom wall 78 of the distribution housing 58 may include a generally triangular recess 104 defined by inwardly slanted walls 106 and a pair of front and rear recess side walls 108. In one embodiment, the included angle between the two slanted walls 106 may be about 90°; however, other included angles between the slanted walls 106 are possible. The front adapter portion 90 of the adapter 86 may extend through the aperture 92 positioned in one of the slanted walls 106 and the other slanted wall 106 of the recess 104, i.e., the wall which does not include the aperture 92, may generally define an approach angle A relative to the bottom wall 78 for accessing the front ports 100 of the adapter 86. In one embodiment, the approach angle A may be between about 30° and about 60°, and preferably may be about 45°. Other values, however, are also possible depending on the specific application. If the distribution housing 58 includes multiple adapters 86, each adapter 86 may have its own dedicated recess 104. Alternatively, each recess 104 may include more than one adapter 86 positioned therein.

In one embodiment, when the adapter 86 is affixed to the distribution housing 58, no portion of the adapter 86 extends beyond the outer boundary or confines of the distribution housing 58. In other words, the accessible portion of the adapter 86 does not extend beyond or outside the recess 104. Alternatively, when the adapter 86 is affixed to the distribution housing 58, only a de minimus portion of the adapter 86 may extend beyond the outer boundary or confines of the distribution housing 58. In this embodiment, for example, the length of any extension of the adapter 86 beyond the outer boundary of the distribution housing 58, as measured perpendicular to the surface of the housing 58 from which it extends (e.g., perpendicular distance from the bottom wall 78), may be no more than 10%, and preferably no more than 5% of the dimension of the housing 58 in that direction (e.g., the dimension of the housing 58 from the top wall 76 to the bottom wall 78). In this way, the adapter 86 provides no substantial protrusion that extends beyond the outer boundary of the distribution housing 58 that might get snagged or otherwise caught up during the installation of the distribution cable assembly 38.

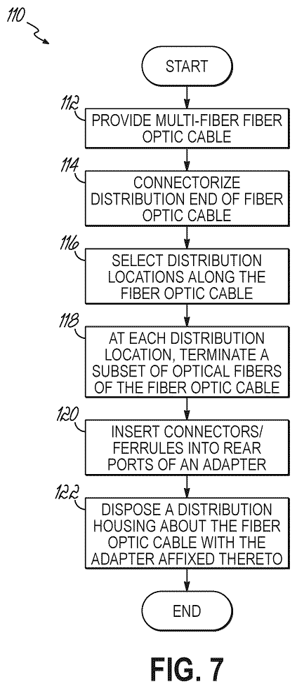

In accordance with an aspect of the disclosure, a flowchart 110 outlining a method of making the distribution cable assembly 38 as described above is illustrated in FIG. 7. The method includes providing a fiber optic cable 40 carrying a plurality of optical fibers 44 in step 112. Next, the distribution end 54 of the fiber optic cable 40 may be connectorized with a plurality of connectors 60 in step 114. A following step 116 includes selecting distribution locations 62 along the length of the fiber optic cable 40 corresponding to the location of the racks 32 in a row 28 of the data hall 26 of the data center 10. Furthermore, at each of the distribution locations 62, the method includes the following additional steps. In step 118, a subset of the optical fibers 44 carried by the fiber optic cable 40 may be terminated by a plurality of connectors and or ferrules 98, 96. In a next step 120, the connector/ferrules of the terminated optical fibers 44 may be inserted into respective rear ports 94 of at least one multi-port adapter 86. In step 122, a distribution housing 58 may be disposed about the fiber optic cable 40 at the distribution locations 62 such that the at least one adapter 86 is affixed to the distribution housing 58. As noted above, the distribution housing 58 may be injection molded parts that are assembled about the fiber optic cable 40 at the distribution locations 62 and the at least one adapter 86 is affixed to the distribution housing 58. Alternatively, the distribution housing 58 may be formed by an over-molding process that includes a portion of the fiber optic cable 40 and the at least one adapter 86. In either of these processes, the at least one adapter 86 is affixed to the distribution housing 58 such that the front ports 100 are accessible from outside the housing 58. Moreover, as described above, the distribution housing 58 may be formed such that the exposed portion of the at least one adapter 86 is substantially disposed within at least one recess 104 of the housing 58.

As noted above, installation time and cost is a major consideration in data center construction. In use, the distribution cable assembly 38 described above provides improvements in these aspects over what is currently available. As pre-engineered solutions penetrate deeper into data center architecture (and fiber optic network architecture in general), it is expected that racks will be shipped from the manufacturing facility with pre-installed components and pre-installed cabling. In this way, the rack only needs to be placed along the desired row in the data hall of the data center, coupled to a suitable power source, and connected to the distribution cable corresponding to the row in which the rack is located. This latter aspect is where the distribution cable assembly 38 of the present disclosure may be particularly beneficial.

For example, prior to the arrival of a rack 32 for a selected row 28 in the data hall 26 of the data center 10, the distribution cable assembly 38 may be installed in the cable tray 36 corresponding to the selected row 28 such that the distribution housings 58 correspond to the anticipated location of the racks 32 that will fill out the row 28. In this regard, the in-line and low-profile nature of the distribution housings 58 facilitates improved installation by eliminating or reducing snagging of the distribution cable assembly 38 during its routing along the cable tray 36. Once the distribution cable assembly 38 is installed, the rack 32 may be positioned in the selected row 28. Because the rack 32 is pre-engineered, the connectors for the network equipment 18 in the rack 32 may be parked near the top of the rack 32. Accordingly, once the rack 32 is in position in the row 28, the connectors at the top of the rack 32 may be plugged into the front ports 100 of the at least one adapter 86 of the distribution housing 58 associated with the rack 32. It should be appreciated that additional racks 32 may be brought in and the process repeated until all of the racks 32 in the row 28 are positioned and connected to the patch panel 34 via the distribution cable assembly 38. According to the above, the installation time, labor and costs for data center construction may be reduced, and the distribution cable assembly 38 as described above facilitates that improvement through not only improved installation (e.g., reduced snagging of the cable during the routing along the cable trays) but also improved plug and play capabilities.

As discussed above, manufacturers and installers continually seek improved devices and processes that make construction of a data center time and cost efficient. To this end, the present disclosure contemplates an improved way to support row distribution cables in a data center. More particularly, the present disclosure contemplates suspending the distribution cable assembly 38 from the cable tray 36 or other type of cable support, as will be discussed below. As used herein, “suspend”, “suspended”, “suspending” refers to the distribution cable assembly being supported by a main cable support that is generally positioned above the distribution cable assembly. As is generally known in the industry, conventional cable supports typically include cable trays 36, as described above and illustrated in FIGS. 2 and 2A, which support the row distribution cables from below. An aspect of the present disclosure flips that around and instead supports the row distribution cables from above. It is believed that a suspended arrangement of a row distribution cable assembly will further decrease cable installation time and costs.

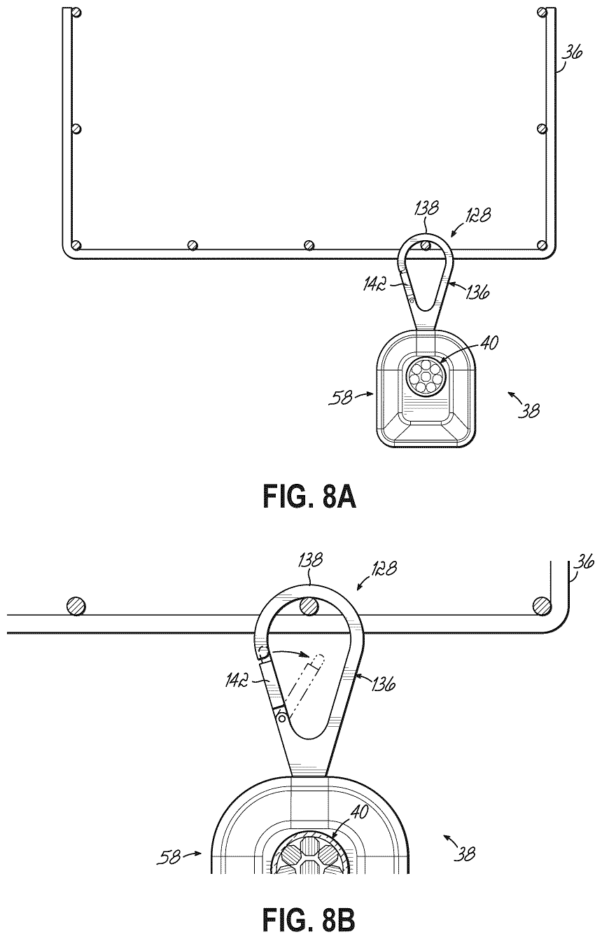

In one embodiment, for example, the distribution cable assembly 38 may be suspended from a traditional cable tray 36. This may occur, for example, when replacing an existing row distribution cable supported by the cable tray 36 (in a conventional sense) with a distribution cable assembly 38 as described above. FIGS. 8A and 8B illustrate such an embodiment. In this embodiment, the distribution cable assembly 38 may be suspended from the cable tray 36 at least at each of the distribution housings 58 of the distribution cable assembly 38. The suspension may be achieved by connecting the distribution housings 58 to the cable tray 36 using one or more cable hangers 128 (two shown). In an exemplary embodiment, the cable hangers 128 may be selectively connected to the distribution housings 58 and selectively connected to the cable tray 36. For example, as illustrated in FIG. 5A and FIGS. 5C-5E, each of the distribution housings 58 may include one or more keyways 130 each configured to receive a respective cable hanger 128. In one embodiment, each of the one or more keyways 130 may be configured as T-shaped slots including a base leg 132 and an intersecting transverse leg 134. In an exemplary embodiment, the one or more keyways 130 may be generally positioned adjacent the top wall 76 of the distribution housings 58. Moreover, the one or more keyways 130 may be positioned in a central region between the front end wall 68 and the rear end wall 70. Alternatively, the one or more keyways 130 may be positioned adjacent the front end wall 68 and the rear end wall 70 of the distribution housing 58. Other locations of the one or more keyways 130 in the distribution housings 58 may also be possible.

In reference to the one or more T-shaped slots, the base leg 132 extends generally perpendicular to the cable axis 40a and in a direction from the front side wall 72 toward the rear side wall 74. In one embodiment, the base leg 132 may be open and externally accessible at both ends of the base leg 132. This allows the cable hanger 128 to be connected to the distribution housings 58 from either end of the slot 130. In an alternative embodiment, however, the base leg 132 may be closed and externally inaccessible from one end of the base leg 132. Thus, the one or more cable hangers 128 may be connected to the distribution housings 58 from only one end of the slot. The closed end of the base leg 132 represents a block or obstacle that prevents the distribution housings 58 from separating from one or more cable hangers 128 at the closed end of the base leg 132. The transverse leg 134 extends generally perpendicular to the cable axis 40a and to the base leg 132 in a direction from the top wall 76 toward the bottom wall 78. One end of the transverse leg 134 may be open to the base leg 132 and the other end of the transverse leg 134 may be open and externally accessible at the top wall 76. This provides the T-shaped configuration of the keyway 130. While the one or more keyways 130 are described as T-shaped slots, other configurations are possible. In general, the keyways 130 are configured to receive, such as slidably receive, a respective cable hanger 128 to selectively connect the cable hanger 128 to the distribution housing 58.

As illustrated in FIGS. 5A, 8A, and 8B, each of the one or more cable hangers 128 include a body or strut 136 having a first upper end 138 and a second lower end 140. The upper end 138 is configured to be selectively connected to the cable tray 36 and the lower end 140 is configured to be selectively connected to a distribution housing 58 of the distribution cable assembly 38. In one embodiment, for example, the upper end 138 may include a releasable clip or latch 142 having an opened and closed position. In the opened position, the upper end 138 of the cable hanger 128 may be connected to the cable tray 36 and in the closed position, the upper end 138 of the cable hanger 128 may be prevented from coming away from the cable tray 36. By way of example and without limitation, the upper end 138 of the cable hanger 128 may be configured similar to a carabiner for selective connection to the cable tray 36. However, other latch-type connectors may also be used at the upper end 138 of the cable hanger 128.

The lower end 140 of the cable hanger 128 is configured to have a profile that corresponds to the profile of the keyways 130 in the distribution housings 58. In other words, the lower end 140 of the cable hanger 128 includes a key 144 that engages the keyway 130 in the distribution housings 58. Thus, in an exemplary embodiment, the lower end 140 of the cable hanger 128 may be T-shaped and includes a bottom flange 146 connected to the main strut 136 of the cable hanger 128. In this embodiment, the bottom flange 146 and a lower portion of the strut 136 collectively define the key 144 that is configured to be received in the keyway 130 in the distribution housings 58 of the distribution cable assembly 38. In one embodiment, the cable hanger 128 may be formed from a suitable metal, such as steel or aluminum. In another embodiment, the cable hanger 128 may be formed from a suitable engineering plastic material, such as those mentioned above. In yet another embodiment, the upper end of the cable hanger 128 may be formed from metal and the lower end may be formed from plastic. While the distribution housings 58 of the distribution cable assembly 38 are described above as including the keyways 130 and the cable hangers 128 are described as having the keys 144, it should be appreciated that in an alternative embodiment, the distribution housings 58 may include the keys 144 and the cable hangers 128 may include the keyways 130 (not shown).

In use, a plurality of cable hangers 128 may be connected to the cable tray 36 at locations corresponding to the distribution locations 62 of the distribution cable assembly 38. The distribution cable assembly 38 may then be routed along the row 28 so that the distribution housings 58 are generally aligned with the (anticipated) racks 32 in the row 28. Next, the lower ends 140 of the cable hangers 128 may be connected to the distribution housings 58 by engaging (e.g., slidably engaging) the keys 144 on the cable hangers 128 with the keyways 130 in the distribution housings 58. In an exemplary embodiment, the keys 144 and the keyways 130 may engage each other through a friction fit. With this engagement, the distribution cable assembly 38 is suspended from the cable tray 36 and the distribution housings 58 are immediately accessible for connecting the network equipment 18 in the racks 32 to the fiber optic cable 40, and thus the patch panel 34 at the head end of the row 28.

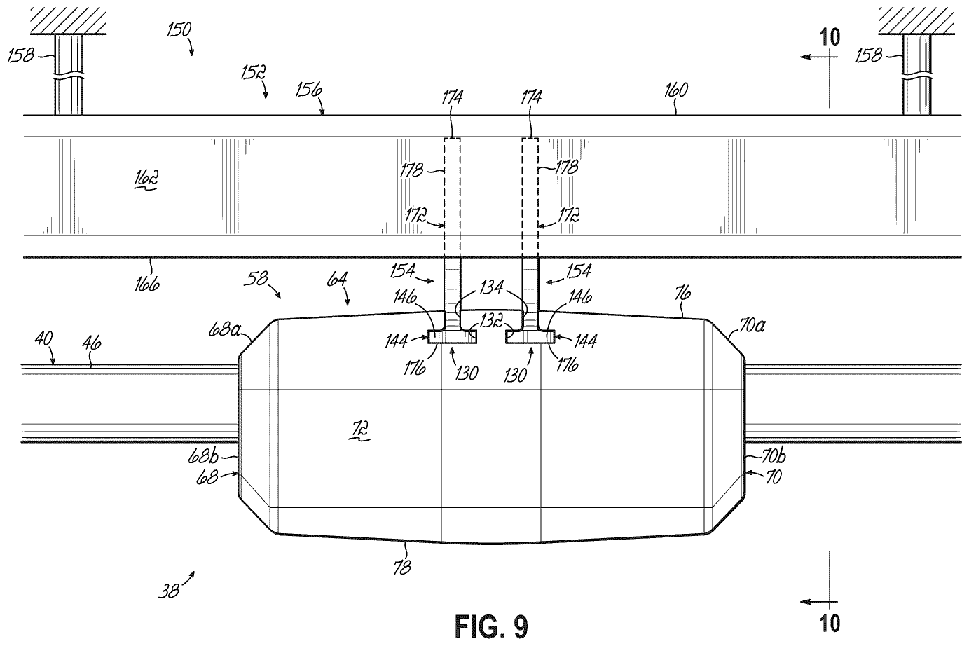

FIG. 9 illustrates a distribution cable system 150 in accordance with another aspect of the present disclosure. The distribution cable system 150 includes the distribution cable assembly 38, a cable support 152, and a plurality of cable hangers 154 for selectively connecting the distribution housings 58 of the distribution cable assembly 38 to the cable support 152. In this embodiment, the distribution cable assembly 38 may be similar to that described above (including the keyways 130 formed in the distribution housings 58) and thus needs no further description here. In an exemplary embodiment, the cable support 152 may include at least one elongate rail 156 (one shown) that generally extends along the length of the row 28 and at a height generally above the racks 32 that are configured to be received in the row 28 (e.g., similar to current cable trays 36; see FIGS. 2 and 2A). The at least one elongate rail 156 is configured to support at least one distribution cable assembly 38 extending along the row 28. The at least one elongate rail 156 may be connected to a plurality of spaced-apart stanchions 158 that are, in turn, connected to the ceiling or other support wall in the data hall 26 to support the at least one rail 156 above the racks 32 in the row 28.

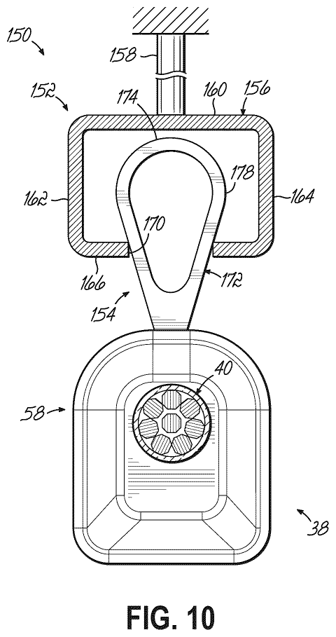

FIG. 10 illustrates an elongate rail 156 in accordance with an exemplary embodiment of the disclosure. In this embodiment, the rail 156 may have an inverted C-shape cross-sectional profile including a top wall 160, front and rear side walls 162, 164, and a bottom wall 166 that collectively define a rail interior 168. The bottom wall includes a slot 170 open to the rail interior 168 for providing external access to the rail interior 168. As discussed in more detail below, the slot 170 is configured to allow a portion of a cable hanger 154 to be selectively received in the rail interior 168 to thereby connect the cable hangers 154 to the rail 156. While the rail 156 is shown and described as being C-shaped with delineated walls, the rail 156 may have other configurations. For example, in an alternative embodiment, the rail 156 may be generally circular in cross-section (not shown) and have a slot at a lower end thereof to provide access to the rail interior 168. Thus, the configuration of the rail 156 should not be limited to that shown and described herein.

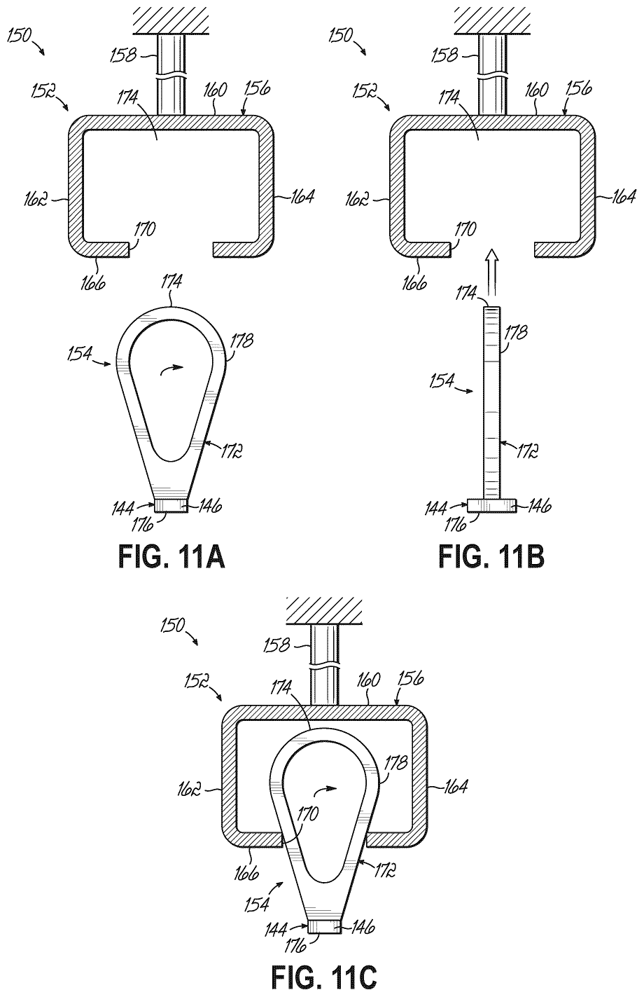

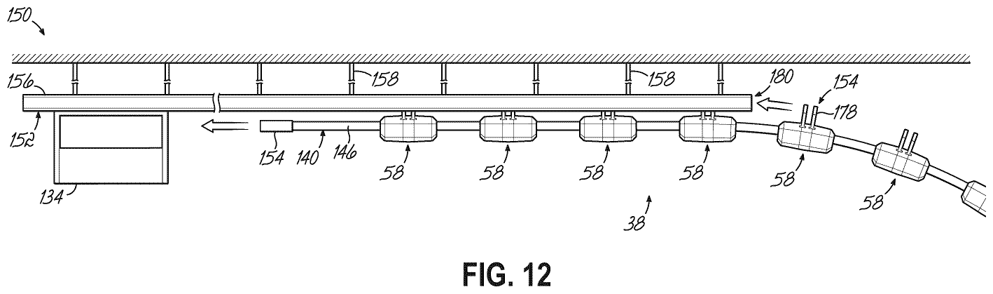

FIGS. 11A-11C illustrates a cable hanger 154 configured to cooperate with the at least one elongate rail 156 for suspending the distribution cable assembly 38. Similar to the above, the cable hanger 154 may include an elongate body or strut 172 having a first upper end 174 and a second lower end 176. In one embodiment, the lower end 176 of the cable hanger 154 may be similar to the lower end 140 of cable hanger 128 described above. In other words, the lower end 140 may include a T-shaped key 144 configured to be received in the keyways 130 in the distribution housings 58 of the distribution cable assembly 38. The upper end 174 of the cable hanger 154, however, may be different. In this embodiment, the cable hanger 154 may be configured to engage with the at least one rail 156 of the cable support 152 in a different way (e.g., as opposed to clipping thereon). For example, in this embodiment, the upper end 174 of the cable hanger 154 may include a bulbous or enlarged head 178 that has a cross dimension that is greater than a cross dimension of the main strut 172. In one embodiment, the head 178 may include an arcuate ring or loop attached to an end of the main strut 172. Similar to the above, the cable hanger 154 may be formed from a suitable metal, plastic, a combination thereof, or other suitable materials.

In use, a plurality of cable hangers 154 may be pre-connected to the at least one rail 156 at locations generally corresponding to the distribution locations 62 of the distribution cable assembly 38. In this embodiment, and as illustrated in FIG. 11B, the cable hangers 154 have a first orientation relative to the at least one rail 156 that allows the head 178 to pass through the slot 170 of the rail 156 so as to position the head 178 in the rail interior 168. As illustrated in FIG. 11C, the cable hangers 154 also have a second orientation relative to the at least one rail 156 that prevents the head 178 from passing back through the slot 170. Thus, to engage a cable hanger 154 with the at least one rail 156, the hanger 154 may be placed in the first orientation and moved so as to pass the head 178 through the slot 170 and into the rail interior 168 of the at least one rail 156. When the head 178 is positioned in the rail interior 168, the cable hanger 154 may be moved (e.g., rotated) out of the first orientation and to the second orientation. In this position, the head 178 cannot pass back through the slot 170 and the cable hanger 154 is captured by the rail 156. While the cable hanger 154 is not permitted to separate from the at least one rail 56 in the second orientation, the cable hanger 154 is permitted to slide along the at least one rail 156 and change its position along the length of the rail 156. Thus, the position of the cable hangers 154 may be adjusted while remaining connected to the at least one rail 156.

With the cable hangers 154 at or near their intended locations corresponding to the distribution points 62 of the distribution cable assembly 38, the cable assembly 38 may then be routed along the row 28 so that the distribution housings 58 are generally aligned with the racks 32 in the row 28. Next, the lower ends 176 of the cable hangers 154 may be connected to the distribution housings 58 by engaging (e.g., slidably engaging) the keys 144 on the cable hangers 154 with the keyways 130 in the distribution housings 58. Again, this engagement may be through a friction fit. With this engagement, the distribution cable assembly 38 is thus suspended from the cable support 152 and the distribution housings 58 are immediately accessible for connecting the network equipment 18 in the racks 32 to the fiber optic cable 40, and thus the patch panel 34 at the head end of the row 28.

In the embodiment described above, the cable hangers 154 were first selectively connected to the cable support 152 and then subsequently connected to the distribution housings 58 to connect the distribution cable assembly 38 to the cable support 152. In an alternative embodiment, however, the cable hangers 154 may be initially connected to the distribution housings 58 and then subsequently connected to the cable support 152. By way of example, the cable hangers 154 may be flexible to some degree to thereby allow the upper end 174 of the hangers 154 to be twisted relative to the lower end 176 of the hangers 154. Accordingly, to connect cable hangers 154 that are already connected to the distribution housings 58 to the at least one rail 156, the cable hangers 154 may be twisted to place at least the enlarged head 178 in the first orientation, thereby allowing the head 178 to pass through the slot 170 and into the rail interior 168. Once the head 178 of the cable hangers 154 are positioned in the rail interior 168, the twisting of the hangers 154 may be released, allowing the head 178 to turn back to the second orientation. This twisting may be done while maintaining the connection with the distribution housing 58. According to this embodiment, when the distribution cable assembly 38 is routed along the rail 28, the connection of the cable hangers 154 to the cable support 152 may be a simple act of twist, raise, and release, which may be accomplished very quickly.

Moreover, because the cable hangers 154 may be attached to the cable support 152 subsequent to the cable hangers 154 being connected to the distribution housings 58, a further feature of this embodiment is that the cable hangers 154 may be formed integrally with the distribution housings 58 of the distribution cable assembly 38. For example, the cable hangers 154 may be formed with the distribution housings 58 during the injection molding or over-molding processes described above. This removes another step from the installation process which may, in turn, further cut down on installation time and costs.

In a further aspect of the present disclosure, the distribution cable system 150 may be configured to permit threading of the distribution cable assembly 38 onto the cable support 152. As used herein, “threading” is a process that permits an end of the distribution cable assembly 38 to be engaged with the cable support 152 at an engagement location 180 of the cable support 152 and then the cable end moved along the cable support 152 as successive distribution housings 58 of the distribution cable assembly 38 are engaged with the cable support 152 at the engagement location 180. In one embodiment, for example, the at least one rail 156 of the cable support 152 may include an engagement location 180 (e.g., an open end of the at least one rail) adjacent the tail end of the row 28. The distribution end 54 of the distribution cable assembly 38 may be positioned proximate the engagement location 180 and moved toward the head end of the row 28 so that engagement hangar 154 associated with an initial distribution housing 58 engages with the rail 156 at the engagement location 180 (e.g., such that the enlarged heads 178 thereof are located in the rail interior 168). The distribution end 54 of the distribution cable assembly 38 may then be further pulled in the direction toward a head end of the row 28. As the distribution end 54 of the distribution cable assembly 38 is being moved toward the head end of the row 28, each time a distribution housing 58 nears the engagement location 180 of the cable support 152, its associated cable hangers 154 may be similarly engaged with the rail 156. In this way, a distribution cable assembly 38 may be quickly connected to and suspended from the cable support 152, and the distribution housings 58 are immediately accessible for connecting the network equipment 18 in the racks 32 to the fiber optic cable 40, and thus the patch panel 34 at the head end of the row 28. In this embodiment, the cable hangers 154 may be separate elements from the distribution housings 58 and connectable thereto as described above. Alternatively, however, the cable hangers 154 may be integrally formed with the distribution housings 58.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable assembly, comprising:
a fiber optic cable carrying a plurality of optical fibers; and
a plurality of distribution housings attached to the fiber optic cable along a length of the fiber optic cable, wherein a subset of the plurality of optical fibers carried by the fiber optic cable is terminated at each of the plurality of distribution housings,
wherein each of the plurality of distribution housings includes at least one port interface for accessing the subset of optical fibers terminated at the respective distribution housing.

2. The fiber optic cable assembly of claim 1, wherein each of the plurality of distribution housings is disposed about the fiber optic cable such that the subsets of the plurality of optical fibers carried by the fiber optic cable extend into an interior of the respective distribution housing.

3. The fiber optic cable assembly of claim 1, wherein the fiber optic cable has a radius R relative to a cable axis, and wherein each of the plurality of distribution housings is in-line with the fiber optic cable such that the respective distribution housing is within an envelope about the cable axis of no greater than about 4R, preferably no greater than about 3R, and even more preferably no greater than about 2.5R.

4. The fiber optic cable assembly of claim 1, wherein for each of the plurality of distribution housings, the port interface comprises:
a first interface portion positioned interior of the respective distribution housing and defining a plurality of interior ports; and
a second interface portion positioned exterior of the respective distribution housing and defining a plurality of exterior ports,
wherein each of the plurality of interior ports is configured to receive one or more of the subset of optical fibers terminated at the respective distribution housing.

5. The fiber optic cable assembly of claim 4, wherein the port interface includes a multi-port adapter.

6. The fiber optic cable assembly of claim 4, wherein each of the plurality of distribution housings includes at least one recess, and wherein the second interface portion of the at least one port interface is substantially positioned in the at least one recess.

7. The fiber optic cable assembly of claim 1, wherein the at least one port interface has an interface axis and a width along the interface axis, and wherein the width of the at least one port interface is between about 1.5 and about 2.0 times the diameter of the fiber optic cable immediately adjacent the respective distribution housing.

8. The fiber optic cable assembly of claim 1, further comprising a plurality of cable hangers for connecting the plurality of distribution housings to a cable support.

9. The fiber optic cable assembly of claim 8, wherein each of the plurality of distribution housings includes at least one key or keyway, and wherein each of the plurality of cable hangers includes the other of the at least one key or keyway, and wherein the respective distribution housing and respective cable hanger are configured to be connected by engagement of the at least one key and keyway.

10. The fiber optic cable assembly of claim 9, wherein each of the plurality of distribution housings includes at least on keyway configured as a T-shaped slot, and wherein each of the plurality of cable hangers includes a key configured as a T-shaped flange.

11. The fiber optic cable assembly of claim 8, wherein each of the plurality of cable hangers includes a clip or latch for selectively engaging the respective cable hanger with the cable support.

12. The fiber optic cable assembly of claim 8, wherein each of the plurality of cable hangers includes an enlarged head for selectively engaging the respective cable hanger with the cable support.

13. A fiber optic cable system, comprising:
a cable support; and
a fiber optic cable assembly that includes:
a fiber optic cable carrying a plurality of optical fibers; and
a plurality of distribution housings attached to the fiber optic cable along a length of the fiber optic cable, wherein a subset of the plurality of optical fibers carried by the fiber optic cable is terminated at each of the plurality of distribution housings, and wherein each of the plurality of distribution housings includes at least one port interface for accessing the subset of optical fibers terminated at the respective distribution housing; and
a plurality of cable hangers configured to connect the plurality of distribution housings to the cable support such that the fiber optic cable assembly is suspended from the cable support.

14. The fiber optic cable system of claim 13, wherein the cable support includes at least one elongate rail, and wherein the plurality of cable hangers is configured to slidably connect to the at least one rail.

15. The fiber optic cable system of claim 13, wherein the at least one rail includes at least one wall defining a rail interior and an opening through the at least one wall for accessing the rail interior, and wherein each of the plurality of cable hangers includes:
a first orientation that allows the respective cable hanger to pass through the opening; and
a second orientation that prevents the respective cable hanger from passing through the opening.

16. A method of making a fiber optic cable assembly, comprising:
providing a fiber optic cable carrying a plurality of optical fibers;
selecting a plurality of distribution locations along a length of the fiber optic cable;
wherein at each of the distribution locations, the method further comprises:
terminating a subset of the plurality of optical fibers with a plurality of ferrules;
providing at least one multi-port adapter including a first portion with a plurality of first ports and a second portion with a plurality of second ports, and engaging the plurality of ferrules of the subset of terminated optical fibers with respective first ports of the multi-port adapter; and
disposing a distribution housing about the fiber optic cable such that the at least one multi-port adapter is attached to the distribution housing and the first portion is in an interior of the distribution housing and the second portion is external of the distribution housing.

17. The method of claim 16, wherein the fiber optic cable has a radius R relative to a cable axis, and wherein disposing the distribution housing about the fiber optic cable further comprises disposing the distribution housing within an envelope about the cable axis of no greater than about 4R, preferably no greater than about 3R, and even more preferably no greater than about 2.5R.

18. The method of claim 16, wherein the distribution housing includes at least one recess, and wherein disposing the distribution housing about the fiber optic cable further comprises locating the at least one multi-port adapter substantially within the at least one recess.

19. The method of claim 16, wherein the distribution housing includes at least one key or keyway formed therein for connecting the distribution housing to a cable support.

20. The method of claim 16, wherein terminating the subset of the plurality of optical fibers with the plurality of ferrules comprises terminating the subset of the plurality of optical fibers with connectors that each include at least one ferrule of the plurality of ferrules.
